(19) United States
(12) Patent Application Publication
(10) Pub. No.: US 2026/0161756 A1
(43) Pub. Date: Jun. 11, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: HAJIME MUTA, Kanagawa (JP)

(21) Appl. No.: 19/394,720

(22) Filed: Nov. 19, 2025

(30) Foreign Application Priority Data
Dec. 6, 2024 (JP) 2024-213391

(51) Int. Cl. G06F 21/31; G06F 21/62; G06T 5/50; G06T 5/60; G06T 5/70; G06V 40/10

(52) U.S. Cl. CPC G06F 21/31; G06F 21/6218; G06T 5/50; G06T 5/60; G06T 5/70; G06V 40/10; G06T 2200/24; G06T 2207/20084; G06T 2207/20092; G06T 2207/20212

(57) ABSTRACT

An image processing apparatus includes a recognition unit configured to perform recognition processing based on acquired recognition information, a setting unit configured to determine permission regarding a setting of an image processing detail based on a result of the recognition processing and set an image processing detail based on the permission, a processing unit configured to perform image processing including at least noise reduction processing on an input image, based on the image processing detail, and an outputting unit configured to output a result of the image processing. The setting unit sets, in a case where it is determined that the permission has been granted, an image processing detail that maintains details of an input image, and sets, in a case where it is determined that the permission has not been granted, an image processing detail that does not maintain the details of the input image.

### BACKGROUND

### Field of the Technology

The present disclosure relates to an image processing technique for a captured image.

### Description of the Related Art

In recent years, apparatuses for enhancing image quality of images captured by cameras or the like using a neural network have been proposed. By using the neural network, image quality enhancement processing, such as noise reduction processing and super-resolution processing, can be executed with higher performance with higher speed than the conventional techniques. In the image quality enhancement processing, it is demanded that not only an entire target object can be visually recognized clearly, but also the details of the target object, such as a minute texture, a person's face, a license plate of a vehicle, and a ship name, can be visually recognized. Thus, techniques for enhancing the image quality while fine details of the captured image are maintained have been proposed.

Japanese Patent Laid-open No. 2015-099546 describes an image processing apparatus capable of reducing noise of image data while the details of a target object are maintained, by generating and combining both first image data, which includes a low-frequency image and an edge image, and second image data including a high-frequency image.

On the other hand, in a case where the image quality enhancement processing is used for monitoring or the like, security control is required for the display of details such as a model number of a monitoring target, a name, a license plate of a vehicle, and a face of a monitoring target, i.e., sensitive information related to, for example, confidentiality or privacy. However, the technique described in Japanese Patent Laid-open No. 2015-099546 cannot perform the security control over a display of details.

### SUMMARY

The present disclosure is directed to a technique for enabling security control for display of details of images.

According to an aspect of the present disclosure, an image processing apparatus includes at least one processor, and at least one memory having stored thereon instructions which, when executed by the at least one processor, cause the image processing apparatus at least to perform recognition processing based on acquired recognition information, determine permission regarding a setting of an image processing detail, based on a result of the recognition processing, set, in a case where it is determined that the permission has been granted, an image processing detail that maintains details of an input image, set, in a case where it is determined that the permission has not been granted, an image processing detail that does not maintain the details of the input image, perform image processing including at least noise reduction processing on the input image, based on the image processing detail, and output a result of the image processing.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of a hardware configuration of an image processing apparatus.

FIGS. 2A and 2B are block diagrams illustrating examples of functional configurations of the image processing apparatus.

FIG. 3 is a flowchart illustrating a procedure of recognition processing.

FIGS. 4A and 4B are flowcharts illustrating procedures of image processing performed based on a recognition result.

FIG. 5 is a diagram illustrating an example of a user interface (UI) for adjusting a composite ratio.

### DESCRIPTION OF THE EMBODIMENTS

Hereinafter, an embodiment related to the present disclosure will be described with reference to the drawings. The following embodiments are not intended to limit the scope of the present disclosure, and not all combinations of features described in the embodiments are necessarily essential to the solutions of the present disclosure. The configuration of the embodiments may be appropriately modified or altered depending on the specifications of the apparatus to which the present disclosure is applied, as well as various conditions such as usage conditions and operating environments.

In the embodiment, image quality enhancement processing is applied to, for example, monitoring, and an example of a security control for a display of sensitive information related to secret information and privacy, such as a model number of a monitoring target, a name, a license plate of a vehicle, and a face of a monitoring target, will be described. It is merely an example, and not limited thereto.

For example, in a case where whether a monitoring target is suspicious is indefinite, it is desirable that the security control to prevent the sensitive information from being spreading unintentionally be performed by concealing the sensitive information until the suspicion of the monitoring target is confirmed. In this case, for example, if the image quality enhancement is performed while details of the image are maintained, the sensitive information can be seen, making the security control ineffective. Thus, it is desirable that the image quality enhancement processing be performed without maintaining the fine details in such a manner that the outer shape of the monitoring target can be clearly obtained while the fine details are not displayed.

In view of the above, an image processing apparatus according to the present embodiment determines whether to perform the image processing that maintains details of an image, such as a model number of a monitoring target, a name, a license plate, and parts of a face of a monitoring target, based on permission regarding an image processing detail. Details will be described below, and the permission regarding the image processing detail according to the present embodiment is permission regarding display of the sensitive information, such as details of the image. In a case where the permission to display the sensitive information, such as details of the image, has been granted, the image processing apparatus performs the image processing that maintains details of the image so that the processed image is allowed to be displayed.

On the other hand, in a case where the permission to display the sensitive information, such as details of the image, has not been granted, the image processing apparatus performs image processing that does not maintain the details of the image so that the details of the image are prevented from being displayed. The image processing apparatus according to the present embodiment performs determination for the permission regarding display of the details of the image (permission regarding the image processing detail) by various methods described below. The image processing apparatus according to the present embodiment performs the image processing including noise reduction processing described below as the image processing. As described above, the image processing apparatus according to the present embodiment switches an image processing method including the noise reduction processing based on the permission regarding display of the details of the image, whereby the security control of the sensitive information can be performed.

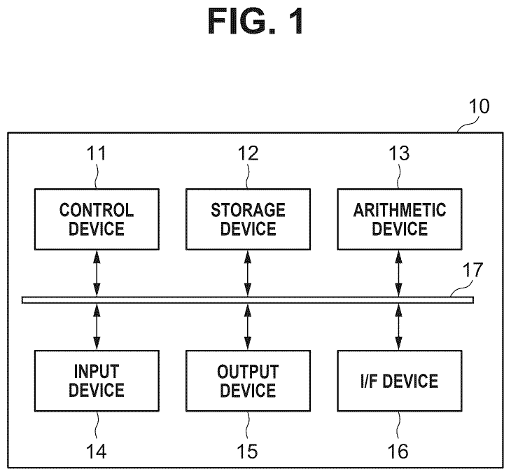

FIG. 1 is a block diagram illustrating an example of a hardware configuration of an image processing apparatus 10.

As a hardware configuration, the image processing apparatus 10 includes, for example, a control device 11, a storage device 12, an arithmetic device 13, an input device 14, an output device 15, an interface (I/F) device 16, and a system bus 17. The control device 11, the storage device 12, the arithmetic device 13, the input device 14, the output device 15, and the I/F device 16 are connected with each other via the system bus 17 so that the components communicate with each other.

The control device 11 controls entire operation of the image processing apparatus 10.

The arithmetic device 13 performs various kinds of calculation processing based on control from the control device 11.

The storage device 12 stores programs and data to be used in operations of the control device 11, and programs and data to be used in calculation by the arithmetic device 13. Examples of the programs held in the storage device 12 include a program (image processing program) related to the image processing according to the present embodiment.

The image processing program according to the present embodiment may be executed by the control device 11 or the arithmetic device 13, or may be executed by the control device 11 and the arithmetic device 13 in a shared manner.

The input device 14 is a human interface device or the like to input a user's operation in the image processing apparatus 10.

The output device 15 is a display or the like to display and present a processing result or the like of the image processing apparatus 10 to a user.

The I/F device 16 includes a wired interface, such as a universal serial bus (USB), Ethernet, and an optical cable, and a wireless interface, such as Wi-Fi® and Bluetooth®. The I/F device 16 has, for example, a function of connecting a camera or the like to the image processing apparatus 10 to input a captured image to the image processing apparatus 10, a function of transmitting a processing result obtained by the image processing apparatus 10 to the outside, and a function of inputting programs, data, and the like to be used in operations of the image processing apparatus 10 to the image processing apparatus 10.

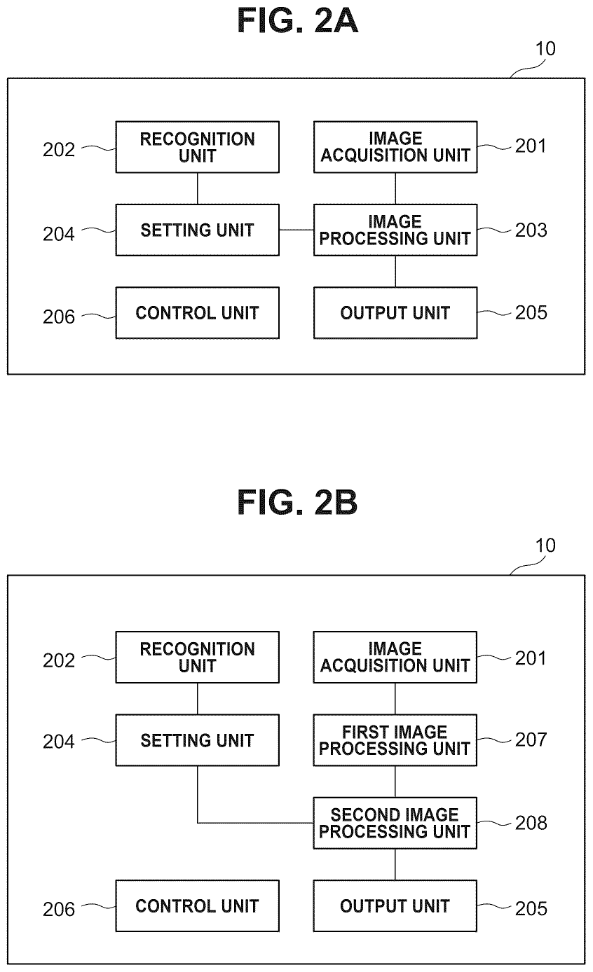

FIGS. 2A and 2B are block diagrams illustrating examples of functional configurations of the image processing apparatus 10 according to the present embodiment.

As a functional configuration, the image processing apparatus 10 illustrated in FIG. 2A includes an image acquisition unit 201, a recognition unit 202, an image processing unit 203, a setting unit 204, an output unit 205, and a control unit 206.

The image acquisition unit 201 acquires an input image from a camera or the like as an image serving as an image processing target of the image processing apparatus 10.

The recognition unit 202 acquires recognition information, performs recognition processing based on the acquired recognition information, and stores the recognition result. Details of the recognition processing performed by the recognition unit 202 will be described below.

The image processing unit 203 performs image processing on the input image acquired by the image acquisition unit 201 according to the image processing detail set by the setting unit 204. Details of the image processing performed by the image processing unit 203 will be described below.

The setting unit 204 determines the permission regarding display of the details of the image as permission regarding the image processing detail, based on the result of the recognition performed by the recognition unit 202, and sets the image processing details to be performed by the image processing unit 203 based on the determined permission. Details of the determination of the permission regarding display of the details of the image, and details of the setting processing of the image processing detail based on the determined permission will be described below.

The output unit 205 outputs the result of the image processing by the image processing unit 203. In the present embodiment, the output unit 205 displays the image processing result on the display of the output device 15 or the like. The output unit 205 also has a function of displaying a user interface (UI) described below.

The control unit 206 controls the entire processing performed by the image processing apparatus 10.

As a functional configuration, the image processing apparatus 10 illustrated in FIG. 2B includes the image acquisition unit 201, the recognition unit 202, the setting unit 204, the output unit 205, the control unit 206, a first image processing unit 207, and a second image processing unit 208. The image acquisition unit 201, the recognition unit 202, the setting unit 204, and the control unit 206 are the same as the corresponding functional units in FIG. 2A. The image processing apparatus 10 in FIG. 2B includes the first image processing unit 207 and the second image processing unit 208, instead of the image processing unit 203 in FIG. 2A.

The first image processing unit 207 performs first image processing on the input image acquired by the image acquisition unit 201. Details of the first image processing that is performed by the first image processing unit 207 will be described below.

The second image processing unit 208 performs image processing according to the image processing detail set by the setting unit 204, on the result of the image processing performed by the first image processing unit 207. Details of second image processing that is performed by the second image processing unit 208 will be described below.

The output unit 205 outputs the result of the image processing performed by the second image processing unit 208, i.e., displays the image processing result on the display of the output device 15 or the like.

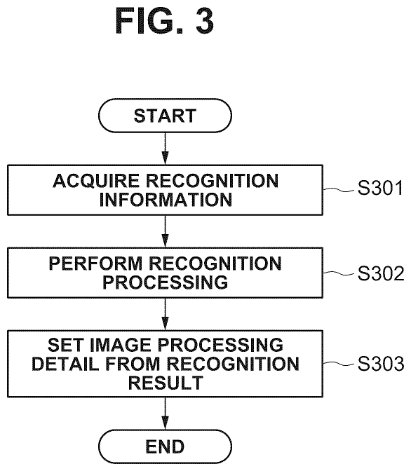

FIG. 3 is a flowchart roughly illustrating the recognition processing that is performed by the recognition unit 202 of the image processing apparatus 10 according to the present embodiment, and the setting processing of the image processing detail that is performed by the setting unit 204 based on the recognition result. The recognition processing performed by the recognition unit 202 is common processing performed in both of the configurations in FIG. 2A and FIG. 2B.

First, in step S301, the recognition unit 202 acquires the recognition information to be used for the recognition processing. For example, the recognition unit 202 acquires any one of or a combination of two or more of pieces of the recognition information described below.

An example of the recognition information that is acquired by the recognition unit 202 in step S301 is identification information for identifying a specific individual. Examples of the identification information for identifying a specific individual include a username, a recognition code, and image data, such as a face, a fingerprint, and an iris of a person. For example, the recognition unit 202 can acquire the identification information for identifying a specific individual via the input device 14 that acquires the recognition code input by a user or registered in a predetermined recognition device, such as a card. Examples of the input device 14 for acquiring the input from a user include a human interface device typified by a mouse, keyboard or the like, and a touch panel. Examples of the input device 14 for acquiring the recognition code from the recognition device, such as a card, include a magnetic card reader, an integrated circuit (IC) card reader, a radio-frequency identification (RFID) card reader, a fingerprint reader, a scanner, and a camera.

Another example of the recognition information that is acquired by the recognition unit 202 in step S301 is position information for identifying a position, such as position information, such as network information and global positioning system (GPS) information. The recognition unit 202 may acquire the position information using the input device 14 or the I/F device 16 included in the image processing apparatus 10, or may acquire the position information using a sensor device, such as a GPS receiver connected to the I/F device 16.

Further, another example of the recognition information that is acquired by the recognition unit 202 in step S301 is device information for identifying a specific device, for example, a device-specific identification (ID). The recognition unit 202 may acquire the device information on the specific device using an external device connected to the image processing apparatus 10, or using an external device connected to the I/F device 16.

After the above-described processing in step S301, the processing by the recognition unit 202 proceeds to step S302.

In step S302, the recognition unit 202 performs recognition processing using the recognition information acquired in step S301, to acquire the recognition result. For example, the recognition unit 202 performs any one of or a combination of two or more of recognition processing methods described below, using the recognition information acquired in step S301.

An example of the recognition processing that is performed by the recognition unit 202 in step S302 is the above-described user recognition processing using the identification information for identifying the specific individual. The recognition unit 202 performs the user recognition using a user name, a recognition code, a device, such as a Radio Frequency Identification (RFID) tag for identifying an individual, or biometric recognition, such as face recognition, fingerprint recognition, and iris recognition, to acquire the recognition result of the identification information. Further, for example, the recognition unit 202 may perform the user recognition based on a different attribute derived from the identification information, for example, information on a user group or a user role, to acquire the recognition result.

Another example of the recognition processing that is performed by the recognition unit 202 in step S302 is recognition processing using position information for identifying a position acquired based on, for example, the above-described network address or the GPS information. The recognition unit 202 acquires the recognition result by using the position information to determine whether the device is a device participating in a specific network or installed at a specific place.

Further, another example of the recognition processing that is performed by the recognition unit 202 in step S302 is recognition processing using the above-described device information for identifying a specific device. Examples of the device information include the number of peripheral devices, a model number, a size, whether a portable storage is connected, and whether a wireless local area network (LAN) or the Internet is connected. The recognition unit 202 acquires the recognition result by using the device information to determine whether the device is a specific device installed at a specific location, or the device is a specific device approved in an inspection performed in advance.

After the processing in step S302 described above, the processing by the image processing apparatus 10 proceeds to step S303 in which the processing is performed by the setting unit 204.

In step S303, the setting unit 204 determines the permission regarding display of the details of the image as the permission regarding the image processing detail, based on the result of the recognition performed by the recognition unit 202, and sets and stores the image processing detail for the subsequent stage based on the determined permission. When the permission is determined, the permission may be determined based on the above-described one recognition result, or may be determined based on the combination of two or more recognition results.

For example, in a case where the recognition unit 202 has performed the recognition processing using the user recognition in step S302, in step S303, the setting unit 204 determines the permission regarding display of the details of the image, based on the recognition result of the user recognition. Then, the setting unit 204 sets the image processing detail for the subsequent stage based on the permission. For example, in a case where the setting unit 204 determines that the person has appropriate permission regarding display of the details of the image from the recognition result of the user recognition, the setting unit 204 determines that the permission to display the details of the image has been granted.

In this case, the setting unit 204 performs the setting so that the image processing that maintains the details of the image is performed in the image processing at the subsequent stage. On the other hand, in a case where the setting unit 204 determines that the person does not have appropriate permission regarding display of the details of the image from the recognition result of the user recognition, the setting unit 204 determines that the permission to display the details of the image has not been granted. In this case, the setting unit 204 performs the setting so that the image processing that does not maintain the details of the image is performed in the image processing at the subsequent stage. In the present embodiment, as described above, examples of the details of the image include a model number of a monitoring target, a name, a license plate of a vehicle, and facial features or organs of a monitoring target person.

Further, for example, in a case where the recognition unit 202 performs the recognition processing using the position information in step S302, the setting unit 204 determines the permission regarding display of the details of the image, based on the recognition result acquired based on the position information. For example, in a case where it is determined that the device corresponding to the position information is a device having appropriate permission regarding display of the details of the image, based on the recognition result using the position information, the setting unit 204 determines that the permission to display the details of the image has been granted. Then, the setting unit 204 performs the setting so that the image processing that maintains the details of the image is performed in the image processing at the subsequent stage. On the other hand, in a case where the setting unit 204 determines that the device corresponding to the position information does not have appropriate permission regarding the display of the details of the image, the setting unit 204 determines that the permission to display the details of the image has not been granted. Then, the setting unit 204 performs the setting so that the image processing that does not maintain the details of the image is performed in the image processing at the subsequent stage.

Further, for example, in a case where the recognition unit 202 performs the recognition processing using the device information in step S302, the setting unit 204 determines the permission regarding display of the details of the image, based on the recognition result acquired based on the device information. For example, in a case where the device corresponding to the device information is a device having appropriate permission regarding display of the details of the image based on the recognition result using the device information, the setting unit 204 determines that the permission to display the details of the image has been granted. More specifically, the setting unit 204 makes the determination that the permission to display the details of the image has been granted, only when it is determined that the device installed at a specific location or the specific device approved in an inspection performed in advance is connected to the image processing apparatus 10, based on the recognition result acquired based on the device information. Then, the setting unit 204 performs the setting so that the image processing that maintains the details of the image is performed in the image processing at the subsequent stage. On the other hand, in a case where the device corresponding to the device information is not a device having the appropriate permission regarding display of the details of the image, the setting unit 204 determines that the permission to display the details of the image has not been granted. Then, the setting unit 204 sets so that the image processing that does not maintain the details of the image is performed in the image processing at the subsequent stage.

In the image processing apparatus 10 according to the present embodiment, the permission determined by the setting unit 204 can be changed later. In a case where the determined permission is changed later, for example, the output unit 205 may display a UI for the setting change on a display.

On the other hand, in a case where the setting unit 204 has set the setting to perform the image processing that does not maintain the details of the image, the setting unit 204 may fix the setting so that the setting cannot be changed later. As a method for setting the setting to be unchangeable later, for example, the output unit 205 may not display the UI for changing the setting, or may display a message indicating that the UI is not operable. The UI in this case may be displayed, for example, on an external display device via the I/F device 16.

The UI may be implemented by the input device 14 or an external setting device connected via the I/F device 16. For example, in a case where the permission to display the details of the image has been granted, the input setting from an external setting device may be enabled, and in a case where the permission has not been granted, the input setting may be disabled. Further, in a case where the external setting device has a display device, information indicating whether the setting is enabled may be displayed on the display device. The display device in this case is, for example, a display or an indicator lamp. Examples of the external setting device include a human interface device, a game controller, a touch panel, a portable terminal, a smartphone, and a tablet.

For example, in a case where the device information on the device connected to the image processing apparatus 10 is changed, the recognition unit 202 may notify the setting unit 204 that the device information is changed. In this case, for example, in a case where the device information is changed after determination about the permission to display the details of the image has been performed, the setting unit 204 considers that any alteration is performed on the device corresponding to the device information, and the setting unit 204 may forcefully remove the permission to prevent leakage of the sensitive information.

Further, for example, in a case where a large size display is connected to the image processing apparatus 10 via the output device 15 or the I/F device 16 of the image processing apparatus 10, the recognition unit 202 may notify the setting unit 204 that the large size display is connected. In this way, in a case where a predetermined device, such as a large size display that has a wide viewing range and the security control thereof is difficult is recognized, the setting unit 204 may determine that the permission to display the details of the image is not granted, or may forcefully remove the permission, to prevent the sensitive information from being viewed.

Other than those described above, for example, for a countermeasure against the intrusion of a suspicious person, a situation in which the details thereof need to be known immediately can occur during the monitoring. An urgent permission may be given by a person with the permission to display the details of the image. In order to be able to deal with such a case, for example, in a case where an urgent permission is input by the person via the input device 14, the setting unit 204 may forcefully grant the permission and changes the setting to the image processing detail that maintains the details of the image.

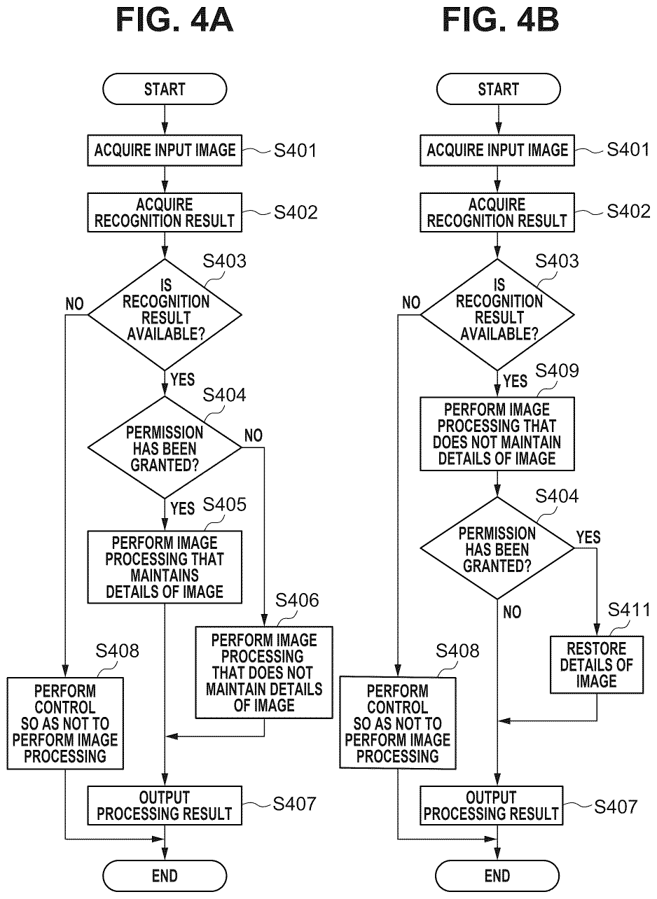

FIGS. 4A and 4B are flowcharts illustrating procedures of the image processing that is performed by the functional configurations of the image processing apparatus 10 in FIGS. 2A and 2B. FIG. 4A illustrates the procedure of the image processing that is performed by the functional configuration illustrated in FIG. 2A, and FIG. 4B illustrates the procedure of the image processing that is performed by the functional configuration illustrated in FIG. 2B.

First, the flowchart in FIG. 4A will be described.

First, in step S401, the image acquisition unit 201 acquires an image serving as an image processing target of the image processing apparatus 10, as an input image. In the present embodiment, the input image is, for example, an image captured by a camera, a streaming image, a moving image file, a series of image files stored for each frame, and a moving image stored in a media. The image acquisition unit 201 may acquire the input image from a solid state image sensor, such as a complementary metal-oxide semiconductor (CMOS) sensor, a charge-coupled device (CCD) sensor, and a single photon avalanche diode (SPAD) sensor, or a camera or the like mounting the solid state image sensor, or may acquire the input image from a storage device such as a hard disk drive (HDD) and a solid state drive (SSD), or a recording medium. The number of the elements, the cameras, the storage devices, and the recording media may be one, or two or more may be provided.

Next, in step S402, the control unit 206 acquires the above-described result of the recognition by the recognition unit 202.

In step S403, the control unit 206 determines whether the result of the recognition by the recognition unit 202 is available. In step S403, in a case where the control unit 206 determines that the result of the recognition by the recognition unit 202 is not available (NO in step S403), or the result of the recognition by the recognition unit 202 has not been acquired from the recognition unit 202, the processing by the control unit 206 proceeds to step S408.

In step S408, the control unit 206 performs control to disable the image processing by the image processing unit 203.

On the other hand, in step S403, in a case where the control unit 206 determines that the result of the recognition by the recognition unit 202 is available (YES in step S403), or the result of the recognition by the recognition unit 202 has been acquired from the recognition unit 202, the processing by the control unit 206 proceeds to step S404.

In step S404, the control unit 206 determines whether the permission to display the details of the image set as described above by the setting unit 204 based on the result of the recognition by the recognition unit 202 has been granted. Then, in a case where the control unit 206 determines that the permission has been granted (YES in step S404), the processing by the control unit 206 proceeds to step S405. On the other hand, in a case where the control unit 206 determines that the permission has not been granted (NO in step S404), the processing by the control unit 206 proceeds to step S406.

In response to the determination that the permission has been granted, in step S405, the control unit 206 controls the image processing unit 203 to perform the image processing that maintains the details of the image according to the image processing detail set by the setting unit 204. In this way, the image processing unit 203 performs the image processing that maintains the details of the image.

On the other hand, in response to the determination that the permission has not been granted, in step S406, the control unit 206 controls the image processing unit 203 to perform the image processing that does not maintain the details of the image according to the image processing detail set by the setting unit 204. In this way, the image processing unit 203 performs the image processing that does not maintain the details of the image.

Then, after the processing in step S405 or step S406, the processing by the control unit 206 proceeds to step S407.

In step S407, the control unit 206 performs control to output the result of the image processing performed by the image processing unit 203 from the output unit 205.

Hereinbelow, the image processing that maintains the details of the image, and the image processing that does not maintain the details of the image will be described using an example case in which noise reduction processing is performed by the image processing unit 203.

First, the image processing that maintains the details of the image in the case in which the noise reduction processing is performed will be described. Examples of the image processing that maintains the details of the image include a method in which the input image, i.e., the original image before the noise reduction processing is combined with the image after the noise reduction processing.

In this case, essentially, the noise reduction processing is processing to remove noise components, i.e., high-frequency components included in the image, and the image after the noise reduction processing is an image including low-frequency components of the input image. However, when the noise reduction processing is performed, for example, by a method of simply removing only the high-frequency components, not only the noise but also the fine details of the image, such as parts of a person's face, characters, and textures, are removed together. On the other hand, the input image has the fine details of the image, even though the noise or the like is included. Thus, the image processing unit 203 according to the present embodiment restores the fine details of the image by performing image processing that combines the input image with the image after the noise reduction processing.

There are various kinds of known processing as the noise reduction processing. Examples of the known processing include noise reduction processing using smoothing processing, filtering processing, wavelet conversion, and a neural network. The neural network used here is a method of achieving the noise reduction processing using a model trained in advance to generate a noise-reduced image from the input image and output the image, and there are various kinds of known neural networks. Examples of the neural network include a convolutional neural network, a recursive neural network, and a transformer.

Examples of the method of combining the input image with the image after the noise reduction processing include an alpha blending method.

When the input image is combined with the image after the noise reduction processing, the composite ratio may be adjusted. It is possible to determine how much the details of the image are maintained by adjusting the composite ratio of the image after the noise reduction processing and the input image. The composite ratio to be used when adjustment of the composite ratio is performed is included in the above-described setting by the setting unit 204. Further, as the composite ratio, a UI for the composite ratio adjustment is displayed, and any composite ratio designated by the user via the displayed UI for the composite ratio adjustment may be used. Details of the UI for the composite ratio adjustment will be described below.

In the above-described example, the example case in which the input image is combined with the image after the noise reduction processing has been described, but instead of combining the input image itself, it is also possible to extract the high-frequency components from the input image and combine the high-frequency components with the image after the noise reduction processing (image including the low-frequency components of the input image). As for processing methods to extract the high-frequency components from the input image, there are various known methods, such as the high-frequency component extraction processing methods using an edge detection by filtering processing, a wavelet transform, and a neural network. The neural network used here is a neural network implementing the high-frequency extraction processing using a model trained in advance to generate and output an image including high-frequency components from the input image, and there are various known neural networks.

In a case where the image processing that maintains the details of the image is performed as described above, fine details regarding a person or an object serving as a monitoring target, such as a person's face, a license plate of a vehicle, a name or an identification number of a ship or an airborne object can be obtained from the image of the image processing result.

On the other hand, as for the image processing that does not maintain the details of the image in the case where the noise reduction processing is performed, there can be the noise reduction processing described above. More specifically, the above-described processing that combines the input image or the high-frequency components of the input image with the image after the noise reduction processing is prevented from being performed. Without combining the original input image or the high-frequency components of the input image maintaining the fine details of the image with the image after the noise reduction processing, an image in a state where the noise has been reduced but the details of the image are not maintained can be obtained.

The image processing unit 203 according to the present embodiment may extract the fine details of the image by performing additional image processing on the image which is the image processing result in which the above-described details of the image are maintained. Examples of the additional image processing for extracting the fine details of the details of the image include a person detection, an object detection, a face recognition, and a character recognition. The image processing unit 203 may further perform an attribute determination of, for example, an identification of a person, a known number or name of a ship, and an aircraft name, based on the image processing result of the additional image processing.

In a case where the image processing unit 203 performs the above-described additional image processing, the output unit 205 may display the result of the additional image processing, or may notify another device or the like of the result of the additional image processing.

The output unit 205 may present the image processing result to the user via the output device 15 of the image processing apparatus 10, or may present the image processing result on another terminal or the like via the I/F device 16.

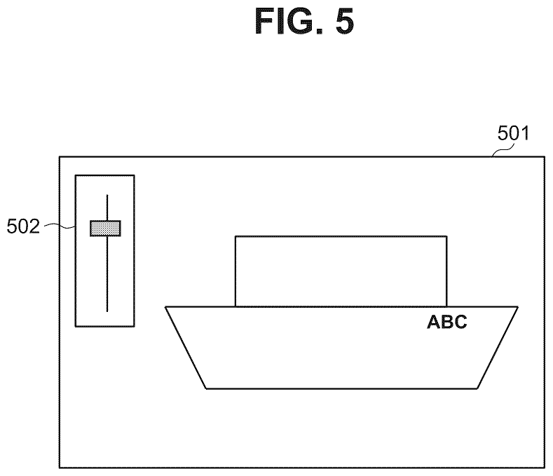

FIG. 5 is a diagram illustrating an example of a UI for the composite ratio adjustment. The output unit 205 of the image processing apparatus 10 according to the present embodiment has a function of displaying the UI that is used for the composite ratio adjustment in the image processing unit 203 based on the result of the recognition performed by the recognition unit 202.

As illustrated in FIG. 5, the UI for the composite ratio adjustment is displayed, for example, as a UI 502 in a slider form in an image 501 output by the output unit 205. In FIG. 5, the slider is exemplified as the UI 502 for the composite ratio adjustment, but it is not limited thereto, and, for example, the UI 502 may be a UI other than the slider, or may be a UI for directly receiving an input of a numeric value of the composite ratio as a parameter. The UI 502 may be displayed outside the image 501 or in a different window.

The parameter of the composite ratio for the image processing that maintains the details of the image by the image processing unit 203 may be set by an external device, and the composite ratio set by the external device may be displayed.

The flowchart in FIG. 4B will be described.

The flowchart in FIG. 4B illustrates the above-described image processing that is performed by the image processing apparatus 10 including the first image processing unit 207 and the second image processing unit 208 illustrated in FIG. 2B. In the flowchart in FIG. 4B, because processing performed in steps S401, S402, S403, S404, S407, and S408 is the same as the corresponding processing illustrated in FIG. 4A, the redundant description is omitted.

In the flowchart in FIG. 4B, in step S403, in the case where the control unit 206 determines that the recognition result is acquired from the recognition unit 202, and the recognition result is available (YES in step S403), the processing by the control unit 206 proceeds to step S409.

In step S409, the control unit 206 performs control to perform the image processing that does not maintain the details of the image by the first image processing unit 207, similar to the above-described processing in step S406. The first image processing unit 207 performs the image processing that does not maintain the details of the image, i.e., performs only the noise reduction processing, and does not perform the above-described composition of the input image or the composition of the high-frequency components of the input image. After the processing in step S409, the processing by the control unit 206 proceeds to step S404.

In step S404, the control unit 206 determines whether the above-described permission determined by the setting unit 204 based on the result of the recognition performed by the recognition unit 202 has been granted. Then, in a case where the control unit 206 determines that the permission has been granted (YES in step S404), the processing by the control unit 206 proceeds to step S411. On the other hand, in a case where the control unit 206 determines that the permission has not been granted (NO in step S404), the processing by the control unit 206 proceeds to step S407.

In the case where the control unit 206 determines that the permission has been granted in step S404 (YES in step S404) and the processing proceeds to step S411, the control unit 206 controls the second image processing unit 208 to perform the image processing that maintains the details of the image, i.e., the image processing that restores the details of the image after the noise reduction processing. Examples of the image processing for recovering the details of the image by the second image processing unit 208 include the processing that combines the original input image or the high-frequency components of the original input image with the image after the noise reduction processing, as described in step S405. Then, after the processing in step S411, the processing by the control unit 206 proceeds to step S407.

In the case where the control unit 206 determines that the permission has not been granted (NO in step S404) in step S404, and the processing proceeds to step S407, the control unit 206 controls the output unit 205 to output the result of the image processing that does not maintain the details of the image by the first image processing unit 207. In the case where the processing proceeds to step S407 after the processing in step S411, the control unit 206 controls the output unit 205 to output the result of the image processing that restores the details of the image by the second image processing unit 208.

In the configuration example of the flowchart in FIG. 4B, the second image processing unit 208 may extract the above-described fine details by performing the above-described additional image processing on the image of the image processing result.

As described above, the image processing apparatus 10 according to the present embodiment can perform the security control by changing the image processing based on the permission to display the sensitive information on the monitoring target.

The present disclosure may also be implemented by supplying a program that realizes one or more functions of the above-described embodiments to a system or apparatus via a network or a storage medium, and causing one or more processors of a computer in the system or apparatus to read and execute the program. Furthermore, the functions may be realized by a circuit (e.g., an ASIC) that implements one or more of the functions. The above-described embodiments are merely examples for embodying the present disclosure, and should not be construed as limiting the technical scope of the present disclosure. That is, the present disclosure may be implemented in various forms without departing from its technical concept or essential features.

According to the present disclosure, it becomes possible to perform security control for display of details of an image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-213391, filed Dec. 6, 2024, which is hereby incorporated by reference herein in its entirety.

What is claimed is:

1. An image processing apparatus comprising:
at least one processor; and
at least one memory having stored thereon instructions which, when executed by the at least one processor, cause the image processing apparatus at least to:
perform recognition processing based on acquired recognition information;
determine permission regarding a setting of an image processing detail, based on a result of the recognition processing;
set, in a case where it is determined that the permission has been granted, an image processing detail that maintains details of an input image;
set, in a case where it is determined that the permission has not been granted, an image processing detail that does not maintain the details of the input image;
perform image processing including at least noise reduction processing on the input image, based on the image processing detail; and
output a result of the image processing.

2. The image processing apparatus according to claim 1, wherein the instructions further cause the image processing apparatus to perform, in a case where the image processing detail that maintains the details of the input image is set, image processing that combines a first image with a second image different from the first image.

3. The image processing apparatus according to claim 2, wherein the first image is an image obtained by the noise reduction processing performed on the input image, and the second image is the input image before the noise reduction processing.

4. The image processing apparatus according to claim 2, wherein the first image includes low-frequency components of the input image, and the second image includes high-frequency components of the input image.

5. The image processing apparatus according to claim 1, wherein the instructions further cause the image processing apparatus to display the result of the image processing and a user interface for changing the image processing detail.

6. The image processing apparatus according to claim 2, wherein the instructions further cause the image processing apparatus to:
display a user interface for adjusting a composite ratio at which the first image and the second image are combined, and
combine the first image and the second image based on the composite ratio adjusted via the user interface for adjusting the composite ratio.

7. The image processing apparatus according to claim 2, wherein the instructions further cause the image processing apparatus to:
acquire a composite ratio that has been set by an external device and at which the first image and the second image are to be combined, and
combine the first image and the second image based on the acquired composite ratio.

8. The image processing apparatus according to claim 1, wherein the instructions further cause the image processing apparatus to output, in a case where the image processing detail that does not maintain the details of the input image is set, an image obtained by the noise reduction processing performed on the input image.

9. The image processing apparatus according to claim 1, wherein the instructions further cause the image processing apparatus to output, in a case where the image processing detail that does not maintain the details of the input image is set, low-frequency components of the input image.

10. The image processing apparatus according to claim 1, wherein the instructions further cause the image processing apparatus to perform additional image processing on the image obtained by the image processing that maintains the details of the input image.

11. The image processing apparatus according to claim 1, wherein the instructions further cause the image processing apparatus to:
perform the image processing that does not maintain the details of the input image, on the input image, and
perform, in a case where the image processing detail that maintains the details of the input image is set, the image processing that maintains the details of the input image, on a result obtained by the image processing that does not maintain the details of the input image.

12. The image processing apparatus according to claim 11, wherein the instructions further cause the image processing apparatus to perform additional image processing on the image obtained by the image processing that maintains the details of the input image.

13. The image processing apparatus according to claim 1, wherein the instructions further cause the image processing apparatus to acquire one or more of identification information for identifying a specific individual, position information for identifying a position, and device information for identifying a specific device, as the recognition information.

14. The image processing apparatus according to claim 13, wherein the instructions further cause the image processing apparatus to:
perform recognition processing that determines whether an individual is a person who has specific permission, based on the identification information for identifying the specific individual, and
determine, in a case where a result of the recognition processing that the individual is the person who has the specific permission is obtained, that the permission has been granted, and set the image processing detail that maintains the details of the image.

15. The image processing apparatus according to claim 13, wherein the instructions further cause the image processing apparatus to:
perform, based on the position information, recognition processing that determines whether a device is a device installed at a specific location, and
determine, in a case where a result of the recognition processing that the device is a device installed at the specific location is obtained, that the permission has been granted, and set the image processing detail that maintains the details of the image.

16. The image processing apparatus according to claim 13, wherein the instructions further cause the image processing apparatus to:
perform, based on the device information for identifying the specific device, recognition processing that determines whether a device is a device installed at a specific location or a device approved in an inspection performed in advance, and
determine, in a case where the result of the recognition processing that the device is a device installed at the specific location or a device approved in the inspection performed in advance is acquired, that the permission has been granted, and set the image processing detail that maintains the details of the image.

17. The image processing apparatus according to claim 16, wherein the instructions further cause the image processing apparatus to remove the permission, in a case where the device information is changed after the determination of the permission.

18. The image processing apparatus according to claim 16, wherein the instructions further cause the image processing apparatus to set the permission to be not granted or remove the permission, in a case where the device identified by the device information is a predetermined device.

19. An image processing method, the method comprising:
performing recognition processing based on acquired recognition information;
setting, by determining permission regarding a setting of an image processing detail based on a result of the recognition processing, an image processing detail based on the permission;
performing image processing including at least noise reduction processing on an input image, based on the image processing detail set in the setting; and
outputting a result of the image processing,
wherein, in the setting, in a case where it is determined that the permission has been granted, an image processing detail that maintains details of an input image is set, and in a case where it is determined that the permission has not been granted, an image processing detail that does not maintain the details of the input image is set.

20. A non-transitory computer-readable storage medium storing a program for causing a computer to execute each process of an image processing method comprising:
performing recognition processing based on acquired recognition information;
setting, by determining permission regarding a setting of an image processing detail based on a result of the recognition processing, an image processing detail based on the permission;
performing image processing including at least noise reduction processing on an input image, based on the image processing detail set in the setting; and
outputting a result of the image processing,
wherein, in the setting, in a case where it is determined that the permission has been granted, an image processing detail that maintains details of an input image is set, and in a case where it is determined that the permission has not been granted, an image processing detail that does not maintain the details of the input image is set.
